(19) United States
(12) Patent Application Publication
(10) Pub. No.: US 2006/0093280 A1
(43) Pub. Date: May 4, 2006

(54) Optical cable with integrated electrical connector

(76) Inventors: Laurence Ray McColloch, Santa Clara, CA (US); Brenton Arthur Baugh, Palo Alto, CA (US)

Correspondence Address: AGILENT TECHNOLOGIES, INC.;Legal Department, DL429, Intellectual Property Administration, P.O. Box 7599, Loveland, CO, 80537-0599, US

(21) Appl. No.: 11/305,741

(22) Filed: Dec. 16, 2005

Related U.S. Application Data
(63) Continuation of application No. 10/603,714, filed on Jun. 25, 2003, now abandoned.

(51) Int. Cl. G02B 6/36

(52) U.S. Cl. 385/81

(57) ABSTRACT

A connection cable includes an optical cable and an integrated electrical connector. The integrated electrical connector is permanently fixed to the optical cable. The integrated electrical connector is for plug-in connection to a matching electrical connector on a target device.

### BACKGROUND

The present invention concerns communication between devices and pertains particularly to an optical cable with an integrated electrical connector.

An electrical cable is often used to establish communication between two devices. Typically, the electrical cable includes an electrical connector at each end. The electrical connectors mate with complementary electrical connectors mounted on each device. For example, a universal serial bus (USB) cable can be used to connect a printer to a personal computer. Similar electrical cables are used for higher data rate connection but the very high data rate electrical cables can be quite costly.

An optical fiber optic (FO) link between two devices can be accomplished by including an FO module within each device and connecting the FO modules on separate devices using one or more FO cables. For example, each FO module is soldered down to a printed circuit board (PCB). Alternatively, the FO module on one or both devices can be “pluggable” into an electrical connector soldered onto a PCB board for the device. For example, Agilent HFBR-5701L/LP small form factor pluggable optical transceivers for Gigabit Ethernet (1.25 GBd) and Fibre Channel (1.0625 GBd) are available from Agilent Technologies, Inc.

Pluggable FO modules can be expensive to produce and to interface with. This is due to the high precision required of the mechanical system which ensures proper performance over temperature, side loads and other external factors. In addition, the FO module and cable have exposed optical parts that are susceptible to contamination, dust, debris, scratches or other damage rendering the connection inoperable.

### SUMMARY OF THE INVENTION

In accordance with the preferred embodiment of the present invention, a connection cable includes an optical cable and an integrated electrical connector. The integrated electrical connector is permanently fixed to the optical cable. The integrated electrical connector is for plug-in connection to a matching electrical connector on a target device.

### BRIEF DESCRIPTION OF THE DRAWINGS

FIG. 1 shows an optical cable with integrated electrical connectors in accordance with a preferred embodiment of the present invention.

FIG. 2 and FIG. 3 show additional detail of an integrated electrical connector for an optical cable in accordance with a preferred embodiment of the present invention.

FIG. 4 shows an electrical connector on a PCB board to which an integrated electrical connector for an optical cable is connected in accordance with a preferred embodiment of the present invention.

FIG. 5 shows an integrated electrical connector for an optical cable connected to an electrical connector on a PCB board in accordance with a preferred embodiment of the present invention.

FIG. 6 is a simplified block diagram of an integrated electrical connector for an optical cable in accordance with a preferred embodiment of the present invention.

FIG. 7 shows detail of a cover for an integrated electrical connector for an optical cable in accordance with a preferred embodiment of the present invention.

### DESCRIPTION OF THE PREFERRED EMBODIMENT

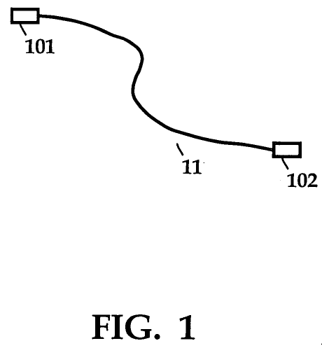

FIG. 1 shows an optical cable 11 with an integrated electrical connector 101 at one end and an integrated electrical connector 102 at the other end. Integrated electrical connector 101 and integrated electrical connector 102 each include optical transceivers; however, to a user, optical cable 11 with integrated electrical connector 101 and integrated electrical connector 102 appears to function as an electrical cable.

Optical cable 11, for example, includes one, two or more optical fibers composed of, for example, plastic or glass or some other material that propagates light. Each optical fiber provides, for example, a single directional link or a bidirectional link. Each optical fiber is, for example, either single mode or multiple mode. For example, depending upon implementation, each optical fiber can carry multiple wavelengths of data, such as short (below 850 nanometer) or long (above 1500 nanometers) wavelengths. For example, wave dependent multiplexing (WDM) can be used for data transfer. Also, digital (serial or parallel) data transmission is used or analog data transmission is used within optical cable 11. For example, analog data transmission is performed using frequency modulation, amplitude modulation, pulse width modulation or another form of modulation. For example, synchronous optical network (Sonet), optical fibre channel, Ethernet, or another optical protocol is used for propagating signals within optical cable 11. Integrated electrical connector 101 and integrated electrical connector 102 are, for example, proprietary electrical connectors or are compatible with a connector standard such as universal serial bus (USB), USB 2, IEEE 1394 (Firewire), Firewire 800, Ethernet, Enterprise Systems Connection (ESCON), Infiniband, a proprietary system interconnection, or another connector standard. A proprietary system interconnection is any connector standard in which one or more entities have ownership rights.

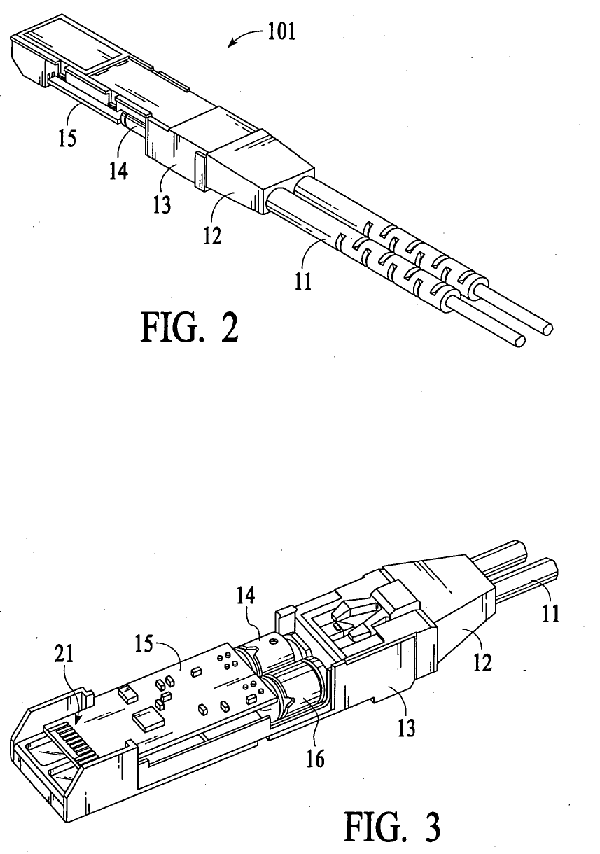

FIG. 2 shows a close up of integrated electrical connector 101 in accordance with one embodiment of the present invention. Integrated electrical connector 101 includes a casing 13. A molding 12 permanently attaches optical cable 11 to integrated electrical connector 101. FIG. 2 also shows part of a printed circuit board (PCB) 15 and a transmit (TX) optical subassembly 14 with semiconductor laser that are part of integrated electrical connector 101.

FIG. 3 shows a close up of another view of integrated electrical connector 101. In addition to casing 13, molding 12, PCB 15 and TX optical subassembly 14, integrated electrical connector 101 is also shown to include a receive (Rx) optical subassembly consisting of a semiconductor photodetector 16. On PCB 15 are placed integrated circuits and passive components as shown. In addition, PCB 15 includes edgecard connections 21 that provide for electrical connection to a matching electrical connector on a target device.

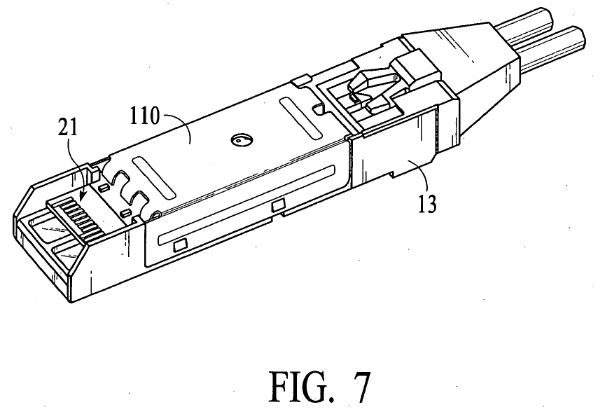

FIG. 7 shows a cover 110 placed to cover and protect TX optical subassembly 14, semiconductor photodetector 16 and components on PCB 15 (shown in FIG. 3).

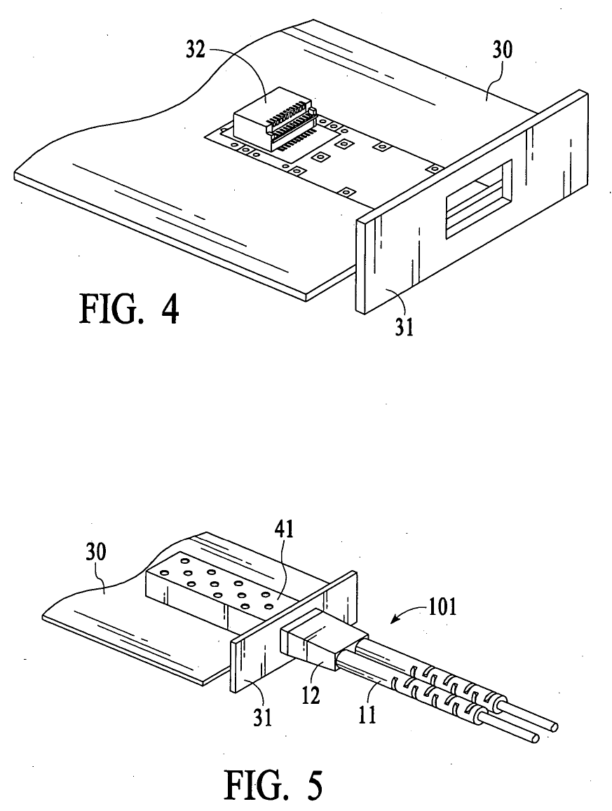

FIG. 4 shows a PCB 30 of a target device on which is soldered an electrical connector 32. Electrical connector 32 provides electrical contact with edgecard connectors 21 on PCB 15 of integrated electrical connector 101 (shown in FIG. 3). A guide 31 guides integrated electrical connector 101 to a correct position for electrical connection with electrical connector 32.

FIG. 5 shows integrated electrical connector 101 inserted through guide 31, through a cage 41, and connected to electrical connector 32 (shown in FIG. 4). When connected, only molding 12 of integrated electrical connector 101 is visible to a user, as shown in FIG. 5.

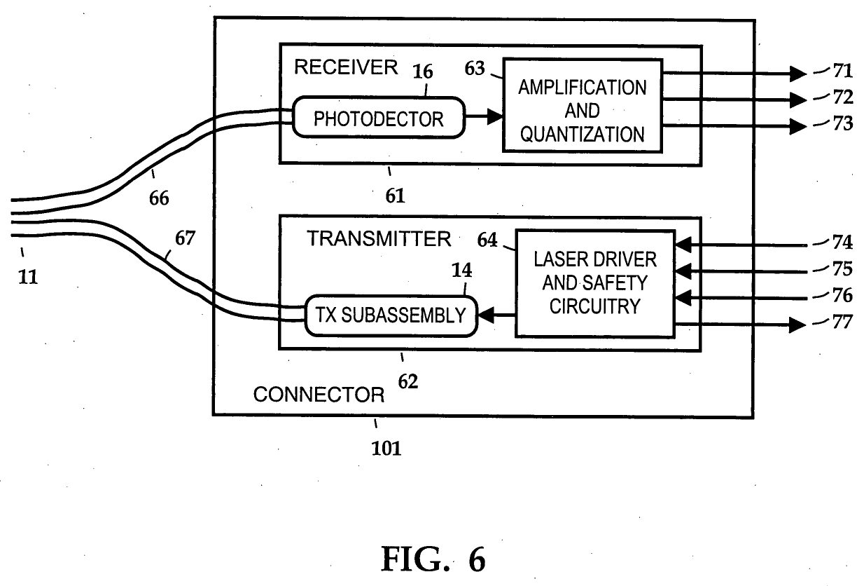

FIG. 6 is a simplified block diagram of one embodiment of an integrated electrical connector 101. In this embodiment, optical cable 11 consists of an optical fiber 66 and an optical fiber 67. Optical fiber 66 and optical fiber 67 each provide a single wavelength single directional link. As discussed above, this embodiment is just illustrative as other embodiments of the present invention include, for example, an optical cable that has only a single optical fiber or an optical cable that has more than two optical fibers. The optical fibers are, for example, single mode or multiple mode. Wave dependent multiplexing (WDM) can optionally be used for data transfer. Data can be transmitted using digital (serial or parallel) encoding of data or analog encoding of data. Implementation of integrated electrical connector 101 is dependent upon both the chosen implementation of optical cable 11 and the type of electrical interface used by the target device.

In the embodiment shown in FIG. 6, photodetector 16 within a receiver 61 detects optical signals on optical fiber 66. Amplification and quantization circuitry 63 produces an electrical output that includes a receive data signal (RD+) 71, a receive data signal (RD−) 72, and a loss of signal (LOS) signal 73.

Laser driver and safety circuitry 64 receives an electrical input consisting of a transmit disable (TX_DISABLE) signal 74, and a transmit data signal (TD+), a transmit data (TD−) signal 76. Laser driver and safety circuitry 64 produces a transmit fault (TX_FAULT) signal 77. Laser driver and safety circuitry 64 also provides an analog laser diode drive current to TX subassembly 14. TX subassembly 14 is, for example, a vertical cavity surface emitting laser (VCSEL) light source.

The foregoing discussion discloses and describes merely exemplary methods and embodiments of the present invention. As will be understood by those familiar with the art, the invention may be embodied in other specific forms without departing from the spirit or essential characteristics thereof. Accordingly, the disclosure of the present invention is intended to be illustrative, but not limiting, of the scope of the invention, which is set forth in the following claims.

We claim:

1. A connection cable comprising:
an optical cable; and,
an integrated electrical connector permanently fixed to the optical cable, the integrated electrical connector being for plug-in connection to a matching electrical connector on a target device.

2. A connection cable as in claim 1 additionally comprising:
a second integrated electrical connector permanently fixed to the optical cable, the second integrated electrical connector being for plug-in connection to a matching electrical connector on a second target device.

3. A connection cable as in claim 1 wherein the optical cable consists of a single optical fiber.

4. A connection cable as in claim 1 wherein the optical cable consists of multiple optical fibers.

5. A connection cable as in claim 1 wherein data transmission through the optical cable is at least one of the following:
digital data transmission;
analog data transmission.

6. A connection cable as in claim 1 wherein the matching electrical connector is compatible with at least on of the following protocols:
universal serial bus (USB) protocol;
USB 2;
IEEE 1394 (Firewire);
Firewire 800;
Ethernet;
Enterprise Systems Connection (ESCON);
Infiniband;
a proprietary system interconnection.

7. A connection cable as in claim 1 wherein data transmission through the optical cable is compatible with at least one of the following:
synchronous optical network (Sonet) protocol; optical fibre channel protocol;
Ethernet protocol.

8. A method for constructing a connection cable comprising the following step:
permanently fixing an integrated electrical connector to an optical cable, the integrated electrical connector being for plug-in connection to a matching electrical connector on a target device.

9. A method as in claim 8 additionally comprising the following step:
permanently fixing a second integrated electrical connector to the optical cable, the second integrated electrical connector being for plug-in connection to a matching electrical connector on a second target device.

10. A method as in claim 8 wherein the optical cable consists of a single optical fiber.

11. A method as in claim 8 wherein the optical cable consists of multiple optical fibers.

12. A method as in claim 8 wherein data transmission through the optical cable is at least one of the following:
digital data transmission;
analog data transmission.

13. A method as in claim 8 wherein the matching electrical connector is compatible with at least on of the following protocols:
universal serial bus (USB) protocol;
USB 2;
IEEE 1394 (Firewire);
Firewire 800;
Ethernet;
Enterprise Systems Connection (ESCON);
Infiniband;
a proprietary system interconnection.

14. A method as in claim 8 wherein data transmission through the optical cable is compatible with at least one of the following:
synchronous optical network (Sonet) protocol; optical fibre channel protocol;
Ethernet protocol.

15. A method for connecting two target devices comprising the following steps:
plugging a first integrated electrical connector permanently affixed to an optical cable into a matching electrical connector of a first target device; and,
plugging a second integrated electrical connector permanently affixed to the optical cable into a matching electrical connector of a second target device.

16. A method as in claim 15 wherein the optical cable consists of a single optical fiber.

17. A method as in claim 15 wherein the optical cable consists of multiple optical fibers.

18. A method as in claim 15 wherein data transmission through the optical cable is at least one of the following:
digital data transmission;
analog data transmission.

19. A method as in claim 15 wherein the matching electrical connector is compatible with at least on of the following protocols:
universal serial bus (USB) protocol;
USB 2;
IEEE 1394 (Firewire);
Firewire 800;
Ethernet;
Enterprise Systems Connection (ESCON);
Infiniband;
a proprietary system interconnection.

20. A method as in claim 15 wherein data transmission through the optical cable is compatible with at least one of the following:
synchronous optical network (Sonet) protocol; optical fibre channel protocol;
Ethernet protocol.
